(19) United States
(12) Patent Application Publication
(10) Pub. No.: US 2006/0292983 A1
(43) Pub. Date: Dec. 28, 2006

(54) Method for data transmission to a receiving station according to the temporal course of the pilot signals

(76) Inventors: Johannes Breitbach, Ulm (DE); Hans Dieterich, Ulm (DE)

Correspondence Address: STAAS & HALSEY LLP, SUITE 700, 1201 NEW YORK AVENUE, N.W., WASHINGTON, DC, 20005, US

(21) Appl. No.: 10/572,323

(22) PCT Filed: Aug. 31, 2004
(86) PCT No.: PCT/EP04/51965

§ 371 Date: Mar. 17, 2006

(30) Foreign Application Priority Data
Sep. 17, 2003 (DE) 103 43 068.7

(51) Int. Cl. H04B 7/24

(52) U.S. Cl. 455/39

(57) ABSTRACT

A data transmission is sent from an emitting station to a receiving station in a radio communication system via an antenna device in the emitting station that produces an electromagnetic field with a temporally changing field intensity at the site of the receiving station. An emission moment for data transmission is defined according to the temporal course of the field intensity at the site of the receiving station, data being transmitted to the receiving station at the emission moment.

### CROSS REFERENCE TO RELATED APPLICATIONS

This application is based on and hereby claims priority to German Application No. 10 343 068.7 filed on Sep. 17, 2003, the contents of which are hereby incorporated by reference.

### BACKGROUND OF THE INVENTION

1. Field of the Invention

The invention relates to a method for data transmission from a sending station to a receiving station in a radio communication system as well as to a corresponding sending station.

2. Description of the Related Art

Mobile radio channels are characterized by the phenomenon of multipath propagation. This means that a radio signal emitted by a send antenna, i.e. a signal modulated onto an electromagnetic wave, is propagated on different paths from a send antenna to a receive antenna. Thus a number of electromagnetic waves, each of which carries the signal, arrive at a receiver, and signal delay differences on the various paths, depending on the location of the receiver, cause constructive or destructive interference of the electromagnetic waves to occur. A stationary radio field is thus formed with locations with especially good reception conditions on the one hand and radio gaps (fading gaps) on the other hand. Depending on their position, user stations can thus receive good coverage, bad coverage or no coverage at all.

When, as is usual in mobile telephone systems, the receiver moves in relation to the radio field, different methods are known for resolving this problem: At low speeds (˜<10 km/h) a fast send power regulation can be used. At higher speeds the effect of radio gaps can be compensated for by interleaving of data to be transmitted. These two methods are used for example in mobile radio systems operating in accordance with the GSM (Global System for Mobile Communications) or the UMTS (Universal Mobile Telecommunications System) standard.

If however user stations which are only moving very slowly or not at all, e.g. portable computers, are to receive data, the methods stated above cannot be employed. With data transmission for which there is provision in the UMTS standard, known as HSDPA (High Speed Downlink Packet Access), user stations which are moving slowly or not moving at all are especially to be supplied at high data rates. To this end all user stations of a radio cell calibrate their radio channel and notify the measured values to the base station providing coverage for a radio cell. Planning functionality included in the base station then ensures that radio resources are explicitly assigned to those user stations which have a particularly good radio channel. User stations which are permanently located in a radio gap are practically excluded from radio coverage in this way whereas user stations with a poor quality radio channel are assigned a radio resource less frequently than user stations with a good quality radio channel. This results in an uneven distribution of the radio resources used for HSDPA. The previously mentioned methods for ensuring radio transmission (send power regulation and interleaving) do not apply since fast send power regulation is not provided for HSDPA and in general the users are only moving at low speed.

### SUMMARY OF THE INVENTION

An object of the invention is therefore to specify an advantageous method for data transmission from a sending station to a receiving station in a radio communication system as well as a sending station which prevents stationary user stations from being excluded from radio coverage and with which it can be ensured that available radio resources are evenly distributed to user stations.

In the inventive method for data transmission from a sending station to a receiving station in a radio communication system the sending station uses an antenna device which generates an electromagnetic field with a field strength which varies over time at the position of the receiving station and defines a sending time for a data transmission at which it transmits data to the receiving station depending on the temporal course of the field strength at the position of the receiving station.

The sending station can ensure, by generating an electromagnetic field which varies over time, that no permanent radio gap appears at the position of the receiving station. Furthermore the sending station can define the send time such that the transmitted data arrives at a point in time at the receiving station at which the greatest possible field strength is present at the position of the receiving station. If a number of receiving stations are present in a radio coverage area of the sending station naturally a field which varies over time can be generated at each position and thus all receiving stations can be individually assigned a send time which makes possible data reception with high field strength, i.e. high quality, in each case. Since for all receiving stations a field strength which varies between a minimum and a maximum value can be generated, there are times for all receiving stations at which a high field strength is present at their position. Radio resources, for example radio channels used for HSDPA, can therefore be distributed evenly to all user stations in the radio coverage area.

The temporal course at the position of the receiving station is known by the sending station for example because of the send power used in conjunction with the known geographical position of the receiving station as well as the characteristics of the possible propagation paths of the electromagnetic waves which generate the electromagnetic field at the position of the receiving station. An assignment specification determined on the basis of measurements or theoretical models is known for example in the sending station with which the sending station can assign to each send power a field strength at the position of the receiving station (for other embodiments of the invention under some circumstances also at each position of its radio coverage area).

In an advantageous development of the invention the sending station receives from the receiving station before data transmission at least one item of information on the basis of which it estimates the temporal course of the field strength. An assignment specification known beforehand in the sending station is then no longer required for estimation of the temporal course of the field strength. The temporal course is instead estimated on the basis of the information.

It is particularly useful if a quality of a signal received from the receiving station at the least two points in time can be obtained from the information. The quality of the received signal is proportional to the field strength at the position of the receiving station so that from a theoretical knowledge of a function which describes the temporal course of the field strength, i.e. the electromagnetic field changes deterministically, an estimation of the temporal course of the field strength at the position of the receiving station can be determined from a quality of the signal assigned to the two points in time in each case.

It is of advantage for the antenna device which generates a field strength which varies over time at the position of the receiving station to include at least two spatially separate antennas which each send out an electromagnetic wave. By using different frequencies for the at least two electromagnetic waves, especially with a frequency difference of between 5 and 50 Hertz, and/or by a change over time of the relative phase angle of the two electromagnetic waves, instead of a stationary electromagnetic field which would be generated for example by an individual antenna, what is known as a wandering electromagnetic field is generated. The temporal course of the field strength is thus theoretically known at the location of the receiving station, i.e. the field strength changes deterministically. The period with which the electromagnetic field oscillates at the position of the receiving station or at each location in a radio coverage area of the sending station is defined by the reciprocal value of the frequency difference of the electromagnetic waves or by that time in which a relative phase change between the two electromagnetic waves of 360° occurs. The period of 50 milliseconds is produced for example with a frequency difference of 20 Hertz. Naturally a wandering electromagnetic field can also be generated with an antenna device which features more than two antennas and thus emits more than two electromagnetic waves with frequencies and phase angles that can be set in the antenna device.

Furthermore it is of advantage if the data to be transmitted is modulated onto the at least two electromagnetic waves.

In a preferred embodiment of the invention the radio communication system is a mobile radio system.

The inventive sending station includes all the features for executing the inventive method.

### BRIEF DESCRIPTION OF THE DRAWINGS

These and other objects and advantages of the present invention will become more apparent and more readily appreciated from the following description of an exemplary embodiment, taken in conjunction with the accompanying drawing of which:

The FIGURE is block diagram of a radio communication system to which the invention is applied.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Without being restricted to this function, a receiving station is referred to as a user station below. A user station is for example a mobile telephone or also a mobile or fixed device for transmission of image and/or tone data for sending faxes, Short Message Service SMS messages and e-mail, and for Internet access. The term also covers a general sending or receiving station of radio communication system.

Without being restricted to this function, a sending station is referred to below as a base station.

The invention can be used advantageously in any radio communication system. Radio communication systems are taken to mean systems in which data is transmitted between stations over a radio interface. Data transmission can be both bidirectional and also unidirectional. Radio communications systems are especially any mobile radio systems operating for example in accordance with the GSM or the UMTS standard. Future mobile radio systems, of the fourth generation for example, should also be understood as radio communication systems.

The invention is described below using a mobile radio system in accordance with the UMTS standard as an example, without however being restricted to this standard.

A base station NodeB is shown schematically in the FIGURE. The base station NodeB is a connected to a fixed network via lines or radio connections not shown in the diagram via intermediate stations, for example radio network controllers (RNC). The base station NodeB features an antenna device AV with two antennas A1, A2 as well as a control unit P for control of the antenna device AV. For transmission of data the base station NodeB emits an electromagnetic wave with a carrier frequency with each of its two antennas A1, A2. The carrier frequencies of the two antennas A1, A2 differ for example by between 5 and 50 Hertz.

Through the frequency difference of the two electromagnetic waves, in a radio coverage area FB of the base station NodeB, instead of a stationary electromagnetic field which can be created for example by a single antenna, what is known as a wandering electromagnetic field is created, i.e. the electromagnetic field changes over time at each position in a radio coverage area FB. The period with which the electromagnetic field changes at a position within the radio coverage area FB of the base station NodeB corresponds here to the reciprocal value of the frequency difference of the electromagnetic waves of the two antennas A1, A2.

Instead of two slightly different carrier frequencies, the base station NodeB can of course also operate the two antennas A1, A2 with one common carrier frequency. In order for a wandering electrical field to be generated in this case too, the phase angle between the electromagnetic waves of the two antennas A1, A2 is varied over time. A temporal change of the phase angle by 7.20 per millisecond produces a phase change by 360° in 50 milliseconds for example. This phase change is equivalent to a frequency difference of the two electromagnetic waves of 20 Hertz at a constant phase angle.

The base station NodeB sends a pilot signal, for example on what is known as the CPICH (Common Pilot Channel) modulated onto the two carrier frequencies, which can be received by all receiving stations within the radio coverage area FB of the base station NodeB. A first user station UE1 which is at a first position P1 receives the pilot signal with a first field strength E1 which changes over time. This is shown by the notation E1 (P1, t), i.e. the first field strength E1 is a function of the first position P1 and the time t. A second user station UE2, which is at a second position P2, likewise receives the pilot signal with a second field strength E2. The location and time dependency of the second field strength E2 is depicted in the FIGURE in the same way as it is for field strength E1.

The maximum value of the two field strengths E1, E2 at the two positions P1, P2 depends on the distance of the first or the second user station UE1, UE2 from the base station NodeB as well as on the propagation paths and the signal attenuation of the electromagnetic waves arriving at the positions P1, P2. The period with which the two field strengths E1, E2 vary at the two locations P1, P2 is the same at the two locations P1, P2 and corresponds to any change of the value of the frequency difference DF of the two carrier waves. The temporal course of the field strengths E1, E2 of the overlaid carrier waves at the two positions P1, P2 is shown schematically in the FIGURE.

The two user stations UE1, UE2 each determine at a first point in time t1′, t2′ and a second point in time t1″, t2″ a quality of the received pilot signal. This takes the form of the signal-to-noise ratio for example. The two user stations UE1, UE2 each send information 11, 12 consecutively to the base station NodeB, from which the quality of the pilot signal received in each case can be taken at each of the two points in time t1′, t1″ or. t2′, t2″. The frequency difference DF between the two antennas A1, A2 and therefore the period with which the field strength changes over time at any given position in the radio coverage area FE is known to the base station NodeB. The base station NodeB thus estimates with reference to the two points in time t1′, t1″ or t2′, t2″ in each case the known quality of the relevant pilot signal, the temporal course of the first field strength E1 at the first position P1 and also the temporal course of the second field strength E2 at the second position P2. Subsequently the base station NodeB defines for the first user station UE1 a first send time t1 at which it transmits data D1, for example by HSDPA, on a first traffic channel (TCH), to the first user station UE1. The two antennas A1, A2 are of course operated with the same carrier frequencies as well as the same frequency difference DF as previously for transmission of the pilot signal on the CPICH. Naturally the pilot signal can also be transmitted on the same channel as the first data D1. For example the CPICH or the first traffic channel can be used in both cases. Instead of the pilot signal the base station NodeB can also transmit data on a traffic channel to the two user stations UE1, UE2. For this data the receive quality can then be determined at at least two points in time in order to subsequently estimate the temporal course of the first and second field strengths E1, E2 at the two positions P1, P2 and to define transmission times for subsequent data transmissions in each case.

The first point in time t1 is selected so that at a first receive time with the value t1+Δt1 a value of the first field strength E1 which is as large as possible is present at the first position P1. Ideally the first receive time is the time at which the field strength is at its maximum at the first position P1. In the same way as previously described, the base station NodeB defines a second send time t2 at which it transmits second data D2 to the second user station UE2. The second data D2 is received by the second user station UE2 at the second receive time with the value t2+Δt2 at which the greatest possible field strength E2 is likewise present at the second position P2.

The electromagnetic fields E1, E2 which vary over time at the positions P1, P2 of the two user stations UE1, UE2 ensure that neither of the two user stations UE1, UE2 can be located in a permanent radio gap. Furthermore the base station NodeB, if further radio stations are located in its radio coverage area FB, can estimate for all user stations in each case a temporal course of the field strengths at the position concerned and thereby evenly distribute to all user stations the available radio resources, for example radio channels available for data transmissions using HSDPA.

Radio communication resources are for example the send power or send intervals as well as spread codes and/or scrambling codes which are used for separation of the different channels and/or user stations at a radio interface.

The user stations shown in the FIGURE are in this embodiment stationary at the first or second position P1, P2. Naturally the invention can also be advantageously employed if the two user stations are moving.

A further advantage of the invention lies in the fact that the entire data throughput of all user stations in the radio coverage area FB is maximized by the even distribution of the available radio resources to all user stations. Furthermore the base station can select the time of sending such that the delay time in the transmission of data packets which arises from buffering in the base station NodeB is minimized.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV 69 USPQ2d 1865 (Fed. Cir. 2004).

1-10. (canceled)

11. A method for data transmission from a sending station to a receiving station in a radio communication system, comprising:
creating an electromagnetic field, using an antenna device at the sending station, with a field strength which varies over time at a position of the receiving station; and
defining, at the sending station, a send time for a data transmission to the receiving station depending on a temporal course of the field strength at the position of the receiving station.

12. A method in accordance with claim 11, further comprising:
receiving at the sending station the receiving station before said defining at least one item of information; and
estimating the temporal course of the field strength based on the at least one item of information.

13. A method in accordance with claim 12, wherein the at least one item of information indicates a quality of a signal received by the receiving station at at least two points in time.

14. A method in accordance with claim 13, wherein the antenna device at the sending station generating the field strength which changes over time at the position of the receiving station includes at least two spatially separated antennas, each of which emits one electromagnetic wave.

15. A method in accordance with claim 14, wherein the at least two spatially separated antennas generate electromagnetic waves with different frequencies.

16. A method in accordance with claim 15, wherein the different frequencies of the electromagnetic waves differ by between 5 and 50 Hertz.

17. A method in accordance with claim 16, wherein a relative phase angle of the electromagnetic waves changes over time.

18. A method in accordance with claim 17, wherein the data to be transmitted is modulated onto the electromagnetic waves.

19. A method in accordance with claim 18, wherein the radio communication system is a mobile radio system.

20. Sending station for transmitting data to a receiving station, comprising:
an antenna device generating an electromagnetic field with a field strength which changes over time at a position of the receiving station;
a control unit defining a send time for a data transmission depending on a temporal course of the field strength at the position of the receiving station; and
means for transmitting the data to the receiving station at the send time.
